(19) United States
(12) Patent Application Publication
(10) Pub. No.: US 2003/0148012 A1
(43) Pub. Date: Aug. 7, 2003

(54) Treatment of germinating malting grain

(76) Inventor: Lionel Scott, Norwich Norfolk (GB)

Correspondence Address: Synnestvedt & Lechner, 2600 Aramark Tower, 1101 Market Street, Philadelphia, PA, 19107-2950, US

(21) Appl. No.: 10/149,044

(22) PCT Filed: Dec. 1, 2000
(86) PCT No.: PCT/GB00/04583

(30) Foreign Application Priority Data
Dec. 3, 1999 (GB) 9928490.3

(51) Int. Cl. A23L 1/168

(52) U.S. Cl. 426/618

(57) ABSTRACT

A method of treating malting grain, in which the grian is subjected to a water restriction stress after commencement of germination under normal conditions. The grain is germinated in a grain-germinating environment but before completion of germination is subjected to said water-restriction stress by reducing the amount of water available to the grain within said environment. This is done for at least one time-interval sufficient to modify, as compared with normally-germinated grain, at least one of the following parameters, namely: (i) the amount of soluble sugars in a hot water extract; (ii) the alpha-amylase level; (iii) the degree of root and shoot growth; (iv) the total nitrogen content and the soluble nitrogen ratio; and/or (v) the diastatic power; as determined in the germinated and thus-treated grain. Preferably the water restriction stress is imparted by lowering the relative humiditity of air flowing around the grain within a germination environment to below 95%. The invention also relates to grain treated by such methods and malt produced from such grain.

The present invention relates to malted grain, a process for germinating and treating malting grain, malt derived from said grain, uses of the said grain and malt derived therefrom. and malted grain and malt derived therefrom obtainable by the said process. In particular, the invention relates to malted grain and/or malt derived from raw grain selected from barley, wheat, sorghum, maize and rye, said malted grain and malt derived therefrom being suitable for use in the brewing, distilling and/or food processing industry, and processes of production thereof and uses therefor.

One of the major industrial uses of monocotyledonous grain, especially barley, is in the malting industry. The malt grain is used inter alia for the production of beers, lagers, ales, stouts, barley wines and whiskies (both single malt whiskies and/or blended whiskies), malt vinegar, malt extract (powders and syrups), diastase, gin, vodka, and alcohol. Rootlets (‘malt sprouts’) from malted grain are also used as feedstuffs for livestock, and may be used in the supply of vitamins and nitrogenous nutrients for micro-organisms (Prescott S. C. and Dunn C. G. (1959) Industrial Microbiology (3^{rd} Edition). London: McGraw-Hill).

Barley grain must be malted before it can be used in brewing or whisky manufacture. Malt is produced by sprouting cereal grains and growing the young seedlings for four to six days under carefully controlled conditions. The quality requirements in malting barley represent a consensus of the specifications required by commercial brewers, distillers and food processors to produce their products in an efficient manner consistent with desired product properties or traditional methodologies (Barley Ed. D. C. Rasmusson 1985, American Society of Agronomy, Crop Science Society of America, Soil Science Society of America, Publishers, Madison, Wis.).

Generally speaking the malting process is designed to provide an acceptable product for the brewer, distiller or food processor in an efficient manner. The overall malting process can be viewed as comprising four steps: Cleaning and sizing of malting grain, steeping, germination and kilning. Cleaning and sizing, for example, over screens and by air flotation, removes contaminating seeds, damaged kernels and other undesirable materials. Once the cleaning is finished, the remaining grain is sized.

Steeping involves placing the cleaned grain in contact with cool water, typically by immersion in cool water, such that the moisture content of the cleaned grain reaches from about 35% to 50%, depending on the nature of the grain and the intended use for the malt. For example, in order to produce a poorly modified traditional pale lager, malt from two-rowed European barley requires steeping to about 41%-43% moisture, while to make a better modified pale ale malt the preferred traditional moisture content would be about 43%-45%. For a high-nitrogen barley (about 1.8% N) destined for a distillery or vinegar factory 46%-49% moisture may be preferred. Higher moisture contents result in faster modification, but hitherto greater malting losses. Thus, many procedures for steeping are used by maltsters depending on the ultimate use for the malt of concern. For example, the first steeping may involve immersion in water with an overflow to remove floating debris and dust. Bottoms of steeping tanks may be fitted with equipment which facilitates the agitation and washing of the grain and to maintain adequate dissolved oxygen. Following this initial step, any one of three procedures as outlined in Barley (1985) supra, page 372, may be employed. The steeping may take from 20 to 70 hours depending on the desired steep-out moisture, the procedure used, kernel size and nature of the grain, and steep water temperature.

Barley from steep is transferred to germination bins, compartments or floors and may, for example, be spread evenly on slotted floors to a depth of up to a metre or more. Air at a controlled temperature (of from about 12°-25° C.) and 100% relative humidity is passed through the grain. The grain may be mixed or turned during this time to minimise maiting of rootlets. Typically, the parameters for germination are 4-6 days growth at 12-25° C. and a final moisture content of from 42-48% depending on design. During this period, the seedlings metabolic systems become fully activated, as evidenced by the emergence of rootlets, growth of the acrospire (coleoptile) and very large increases in respiration and heat output (Barley 1985 supra, page 374).

Following on from germination the malted grain termed ‘green malt’ is dried once the coleoptile has attained a length of from about 75% to 100% of the length of the kernel. Drying of the ‘green’ malt is done in a kiln. For example, in the production of lager-beer, drying may be carried out in a kiln into which air at 40°-60° C. is forced, the purpose being to reduce malt moisture levels to about 20%. The malt can then be subjected to further kilning at an elevated temperature of from about 60°-85° C. Malt destined for brewing purposes is typically dried in this manner to a moisture content of from 4-5% moisture.

Malt destined for distillers is dried to about 6% and using a lower temperature to preserve maximal diastatic activity.

The skilled artisan will appreciate that the kilning may last from 18 h to 4 days and the air temperatures vary in the range of from 30° C. to 105° C. depending on the type of kiln being used, the type of malt being kilned, the stage of the kilning process, and the intended end use of the malt.

The purpose behind kilning is to remove as much of the moisture as possible at relatively low drying temperatures such that enzymic activities are retained. Higher drying temperatures are necessary for curing malt (ie promoting formation of melanoidins which contribute to malt flavour and aroma). Once kilning is finished, the malt is allowed to cool, rootlets (that is culms, coombes, cummins, and sprouts) are removed and the cleaned malt can be stored, ready for use in the brewing or the distilling process proper.

Thus, it can be appreciated that in conventional malting processes, such as the ones in which barley is the grain of choice, selected barley grain is first steeped to achieve a particular moisture level; water is drained from the grain, and the grain may be transferred to a location where it germinates. Conditions are regulated to keep the grain cool (generally below 18° C.) and to minimise water losses. As the grain germinates the ‘acrospire’ (coleopble, spire, blade) grows beneath the husk and pericarp, while the ‘chit’ (coleorhiza, root-sheath) appears at the base of the grain, and is split by the emerging rootlets. At intervals the grain is mixed and turned to provide more uniform growth opportunities, and to prevent the roots matting together as the embryo grows, the endosperm undergoes ‘modification’, that is, its structure is altered by hydrolytic enzymes, which accumulate in the tissue. When ‘modification’ is sufficient it is stopped by kilning the ‘green’ malt, that is, by drying and cooking it in a current of hot, dry air (Briggs, D. E. 1978, Barley. Chapman and Hall, London pages 541-545). It can be appreciated that during the malting process, that is, up to the point of kilning, the embryo continues to grow as it undergoes ‘modification’, the growth thereof being terminated by or during the kilning step. After kilning, the dry, brittle culms are separated and the resultant malt may be stored in dry form or used. Malt from barley may be crushed (unlike barley grain) and can be stored in a crushed or uncrushed state ready for use later on.

An example of later use is in brewing: typically, the cleaned malt (in crushed or powder or non-crushed form) can then be mashed, that is, subjected to a combined extraction and autolytic process designed to maximise production of fermentable materials. For example, in the production of lager-type beers, crushed malt is combined with brewing water at 35°-50° C. to the consistency of thin porridge. After a standing period, typically of about 20-30 minutes (protein rest), a source of carbohydrate, termed “adjunct” may be added in the form of hot gelatinised rice or corn grits (cooker mash). Addition of mash with rapid agitation raises the temperature of the combined mash to 68°-70° C. Conversion of starch is permitted to proceed at this temperature for typically about 15-20 minutes after which the temperature is increased to a level to inactivate the bulk of the remaining enzymes, typically the temperature is about 80° C. The ratio of malt to adjunct in a combined mash may vary from about 50:50 to 75:25. All-malt mashes also are prepared in the production of some premium beers, and usually when liquid adjuncts are added subsequent to mashing.

After mashing the combined mash is transferred to a filtration vessel from which the filtrate, termed ‘wort’ is drawn off. After drawing off of the wort, the spent malt may be sprayed with warm water (sparge) to remove most of the remaining solubles or extract. The product, sweet wort, may then be processed downstream, for example, in the production of beer-lagers, wort may be transferred to boiling kettles or coppers for further processing steps, such as the addition of hops, fermentation and lagering, and the like.

It will be appreciated that there are many factors which affect the brewhouse yield of malt. Malting and brewing processes involve many complex biochemical reactions. During malting, conditions are selected to maximize endosperm breakdown (ie endosperm modification) while at the same time acrospire and rootlet growth may be minimised but not arrested by the addition of certain additives, such as potassium bromide, prior to kilning. The purpose of malting is to convert a hard relatively insoluble kernel of grain, such as barley, into a friable, relatively soluble kernel of malt. Yield of soluble malt extract is of great economic importance to brewers as it is related to brewhouse yield of wort. Brewhouse yield determines the amount of beer that can be produced from a particular quantity of barley malt.

It can be appreciated that the conversion of raw grain, such as barley into malt incurs losses of dry matter. These losses are: (i) materials dissolved or dust washed away in the steep; (ii) the respiratory loss of water and carbon dioxide, and (iii) the rootlets. The rootlets have a monetary value (less than that of the malt on a weight basis), but the steep effluent is a liability as its high biological oxygen demand must be reduced before it can be allowed into any waterway. The maltster aims to reduce malting losses to a minimum, while producing good malt in as short a time and in as economical a manner as possible.

In conventional malting/brewing processes as alluded to above, there is a requirement that the grain is permitted to grow while the endosperm undergoes ‘modification’ as outlined hereinbefore. The present inventor has found that germination or sprouting, that is, growth of roots and shoots (‘rootlets’ as defined hereinafter) can be arrested under certain conditions while the endosperm undergoes modification, resulting in the grain being able to acquire altered levels of certain measurable components relative to levels of such measurable components found under conventional germination conditions, which altered levels of components, may be useful to the maltster, brewer, distiller and/or foodstuff producer, such as altered levels of total nitrogen content and therefore altered soluble nitrogen ratio, altered diastatic power, altered sugar levels, for example in hot water extract, and altered alpha-amylase activity and a greater ability to control arrestation of root and shoot growth without substantially affecting the quality of malt produced from malting grain. Typically, the altered levels of such measurable components are reflected as increases relative to the levels typically found under conventional germination and/or malting conditions, although in certain cases decreases may be desirable. Such changes of measurable components are desirable in brewing processes, whisky manufacture and food processing of grain. Naturally, the man skilled in the art will appreciate that different varieties of grain subjected to a process or processes according to the invention will give results which are variety dependent.

For the first time there is provided a modified malting process which provides for the obtention of malt in which one or more of the following advantages can be realized through the simple manipulation of water availability in the grain germinating environment and thereby, impose a mild to moderate water stress to the grain:

(i) the level of soluble sugars found in hot water extract from malted grain produced by the modified malting process of the invention may be elevated relative to the levels of soluble sugars, for example, found in hot water extract from malted grain produced under conventional conditions;

(ii) alpha-amylase levels may be increased relative to alpha-amylase levels found in malt produced under conventional malting methods;

(iii) a greater ability to control arrestation of root and shoot growth without substantially affecting the quality of malt produced from the malting grain. The growth of rootlets is arrested during the ‘modification step’ (ie during germination) in the preparation of malted grain suitable for downstream use, for example, in brewing, distilling, and/or food processing prior to kilning, hence the amount of waste in the form of rootlets is substantially reduced;

(iv) total nitrogen content may be increased and therefore soluble nitrogen ratio may also be increased;

(v) diastatic power may be increased.

It is thought that losses due to the respiratory loss of water and carbon dioxide are also substantially reduced. Furthermore, such improvements in the malted grain are obtainable without the need for further capital investment in industrial hardware. In addition, it has been found that grain varieties currently used in the brewing and/or distilling industries are able to undergo modification as described and exemplified herein with the result that such varieties acquire altered levels of at least one or more of the parameters mentioned under (i)-(v) above relative to the same varieties germinated under conventional germinating conditions.

These and other advantages of the instant invention will become apparent from the following description and examples.

According to the present invention there is provided a method of treatment of malting grain, in which the grain after commencement of germination under normal conditions within a grain-germinating environment but before completion thereof is subjected to water-restriction stress by reducing the amount of water available to the grain but maintaining an adequate oxygen supply to the grain within said environment for at least one time-interval sufficient to modify, as compared with conventionally germinated non-water stressed grain, at least one of the following parameters, namely:

(i) the amount of soluble sugars in a hot water extract;

(ii) the alpha-amylase level;

(iii) the degree of root and shoot growth;

(iv) the total nitrogen content and the soluble nitrogen ratio; and/or

(v) the diastatic power; as determined in the germinated and thus-treated grain.

According to another embodiment of the invention there is provided a method of treatment of malting grain comprising the steps of:

a) treating the grain at a first relative humidity of at least 95%, at a temperature In the range from 12 to 25° C. for at least a first period of time; and

b) on at least one occasion during this treatment reducing the relative humidity to less than 95% and continuing to treat the grain at the said reduced relative humidity for at least a second period of time.

Steps a) and b) do not require the addition of chemical additives. Arrestation of rootlet growth is observed under the modified germination conditions and may be achieved substantially independently of the addition of chemical additives, such as potassium bromate (KBr), gibberellic acid (GA), and without physically damaging the seed.

According to a preferred embodiment of the invention there is provided a method of malting grain which comprises incubating malting grain in a grain germinating environment which is conducive to the arrestation of the growth of rootlets wherein the arrestation of rootlet growth does not require the addition of rootlet growth arresting agents, such as KBr, and the like.

In a further embodiment of the present invention there is provided a method of arresting rootlet growth in grain by incubating the said grain in a grain germinating environment wherein active addition of water to the grain is withheld for a time interval conducive to the alteration of one or more of parameters (i)-(v), above.

Naturally, the skilled addressee will appreciate that in certain malting practise, GA, that is a commercial GA, such as GA derived from the fungus Gibberella fujikuroi, may be added to increase the level of enzymes such as amylase, glucanases and endo-proteases in the grain. However, generally, the brewing and distilling industries are cautious in using grain which has been treated with added GA and/or KBr because of the risk of excessive proteolysis occurring in the endosperm of the grain.

For the purposes of the present invention ‘grain’ and ‘malting grain’ means monocotyledonous raw grain (untreated grain) suitable for use in the brewing, food processing and/or distilling industries. Typically, malting grain is grain which has certain attributes which are of value to such industries. Thus, certain varieties of monocotyledonous plants which do provide raw grain are not suitable for use in such industries inter alia because the grains may lack certain attributes of value to the said industries, and therefore may be of no practical use for malting purposes. The skilled artisan will appreciate that the screening of grain for attributes of interest to the brewing, distilling and/or food processing industries is a matter of routine. Malting grain includes grain suitable for brewing, food processing and/or distilling selected from barley, wheat, sorghum, maize and rye, more preferably from barley and rye, and most preferably, barley. Barley varieties suitable for malting include winter and spring barleys. Examples of commercially available barley varieties suitable for malting include inter alia Maris Otter, Golden Promise, Fanfare, Chariot and Halcyon. Thus, the skilled artisan will appreciate that certain varieties of monocotyledonous plants of the same species, for example, barley varieties, are not suitable for brewing purposes since such varieties may be deficient in one or more attributes of interest to the brewing, food processing and/or distilling industry. Typically, brewing barleys (Hordeum distichon or Hordeum vulgare) may be either 2- or 6-rowed, the 2-rowed being generally more favoured in Europe and Australia and the 6-rowed being more favoured in the USA and Canada.

The grain germinating conditions must be such that the malting grain is permitted to germinate under conventional germination conditions for a period of time before being subjected to a period of mild water stress such that the growth of rootlets is arrested but the moisture content of the grain is high enough to permit measurable alterations, typically elevations in the levels of one or more of at least (i)-(v), above. The moisture content of the grain before the mild water stress treatment typically lies between 42-50%. After a mild water stress treatment the moisture content of the grain may depend on the particular grain type and even the variety of grain used but will in general not be lower than about 30% by weight of the seed, more typically between about 32%-45% depending on the proposed end use. Thus, the modified germinating conditions of the present invention in the context of the malting of grain rely in part on with-holding water from the grain for a time interval during the germinating period. The initial moisture content of the malting grain may be equal to that of steeped grain, although it is envisaged that a lower moisture content, for example after the seeds have been exposed to a normal germinating environment for a period of hours, may give rise to a quicker increase in the levels of one or more of at least (i)-(v) above, in the grain, once the mild water-stress conditions are imparted to the germinating environment. The aim of the modified germinating conditions is to place the malting grain under a mild to moderate water stress with a view to arresting rootlet growth, and altering measurable parameters, such as (i)-(v) above, within the grain. ‘Rootlets’ as this term appears herein is to be taken to mean ‘roots and shoots’ which encompasses the growth of the acrospire (coleoptile, spire, blade) and roots.

In the context of germination as it relates to the preparation of grain suitable for malting purposes in the brewing, distilling and/or food processing industries, the steeped grain in which germination has been initiated and permitted to continue for a period of time, may then be subjected to environmental conditions for a further period of time wherein growth of rootlets is arrested. For example, steeped barley grain can be permitted to germinate for a period of time between a few hours up to 6 days or more, for example, 1-4 days at 100% relative humidity, adequate oxygen (eg air) supply and at a suitable temperature, such as 18° C. At the end of such a time period the coleoptile will be about 3-4 mm in length. The grain of interest, in this illustration, barley, can then be placed in a closed container at a lower relative humidity, for example less than 95%, such that water is withheld from the grain. It is envisaged that in the germinating step of a malting process, once the grain has undergone modification in the germination step, for example, for 48-72 hours, the water vapour level may be reduced or withdrawn from the incoming oxygen (air) supply (under conventional germinating conditions air is typically supplied at and maintained at from 95-100% relative humidity). The air in the germination chamber may then be permitted to re-circulate thereby giving rise to a mild water stress by the withholding of additional water from the grain. The grain can be held under such conditions for a period of time ranging from 24 hrs up to several days or more, for example up to 6-10 days, more preferably 6 days or less and most preferably from 2-4 days or less. However, for malting purposes, the amount of time the grain spends in the mild water stress phase of the modified germination step generally lies between 24-96 hours, preferably from 24 to 72 hours, and most preferably from about 24-48 hours depending on design. Naturally, the skilled artisan will appreciate that the amount of time the malting grain is subjected to the mild water stress phase of the germination step will vary between grain varieties, and will in part be dependent on the desired end use of the grain being treated, for example, what type of lager, ale, beer, stout or other liquor such as whisky, vodka or other distillation product, such as malt vinegar, the malted grain is intended for. During this second time interval moisture gain is limited by the with-holding of water. The germinated malting grain undergoing the mild water stress can be held at any temperature within the range of from 0° C. up to about 25° C., preferably within the range of from 0° C.-18° C., and most preferably from about 10° C.-18° C. The relative humidity is typically less than 95% relative humidity.

In a variant of the germination step outlined above, germinated malting grain may first be dried back relatively quickly under conventional drying procedures and then subjected to mild water stress conditions as outlined above. Thus, the moisture content may initially be reduced to, for example, a moisture content which is about 10% lower than that which germinated malting grain has normally. Satisfactory results may be obtained when the moisture content is between about 0.5%-5% lower, particularly between about 2%-5% lower than that which germinated malting grain normally has depending on species and/or variety, and desired end use of the malting grain. In general it is advantageous not to reduce the moisture content of the malting grain to less than about 30-35% by weight of the grain, for example 32%. For instance, the malting grain may be subjected to a temperature lying between 0° C.-25° C., at a relative humidity within the range of from 30%-90%, in still air or in flowing air at speeds typical for conventional drying back of grain. Suitable drying conditions may be 20° C., at a relative humidity of 40% in air flowing at a speed of 2 m/s over 5 minutes.

Germinated malting grain in which an alteration in one or more of parameters (i)-(v) above, is to be induced, may be dried back to an overall water content sufficient to permit metabolic processes to continue but sufficiently below that of germinating grain so as to substantially inhibit rootlet growth. Typically, the water content of the grain will lie in the range of from about 30%-about 55%, more preferably from about 35%-50% by weight of malting grain depending on species, variety, and desired end use of the malting grain.

After drying back, the malting grain may be transferred to an environment wherein moisture loss is prevented (for example a closed container), and subjected to conditions wherein rootlet growth is arrested as hereindescribed.

Water content of mated grain may be calculated using the following formula:

$$\frac{Wi - Wa}{Wi} \times 100$$

where

Wᵢ=weight initial

Wₐ=weight after oven drying grain at 103° C. overnight

According to a further embodiment of the invention there is provided a method of malting grain comprising the steps of

(i) cleaning and sizing;

(ii) steeping;

(iii) germinating; and

(iv) kilning

wherein the germinating step (iii) further comprises incubating the malting grain in a relative humidity of less than 95% for a total time period conducive to the arrestation of rootlet growth prior to the kilning step (iv), as outlined above.

After the germination step is completed, the malted grain, termed ‘green malt’ may then be kilned inter alia for imparting flavour characteristics to the malt; and/or to dry the malt back prior to storage. It is envisaged that a further advantage of the process of the present invention is that the period of time spent in the kilning step is shortened relative to conventional malting processes and as a consequence the amount of energy required for the kilning step is significantly reduced.

The skilled artisan will appreciate that steps (i), (ii) and (iv) are known in the art and general descriptions of these steps can be found in, for example, 1. Brewing Room Book (1998-2000), Ed. RHB Beach, Paul's Malt, Brewing Materials, ‘Malt’ pages 219-230; and 2. An Introduction to Brewing Science & Technology (1983), Eds Rainbow C and Float G. E. S., The Institute of Brewing, 33 Clarges Street, London, W1Y 8EE, England, Chapter 2 ‘Malting and Mashing’, pages 10-27, the teaching of which (ie 1 and 2) is herein incorporated by reference. The skilled addressee will also appreciate that the germinating environment for the conventional germinating step (iii) is also known in the art.

According to a further embodiment of the invention there is provided germinated and treated grain in which, at least one of the following parameters, namely:

(i) the amount of soluble sugars in a hot water extract;

(ii) the alpha-amylase level;

(iii) the degree of root and shoot growth;

(iv) the total nitrogen content and the soluble nitrogen ratio; and/or

(v) the diastatic power;

has been modified in comparison to conventionally germinated non-water stressed grain.

According to a further embodiment of the invention there is provided treated green malt in which, at least one of the following parameters, namely:

(i) the amount of soluble sugars in a hot water extract;

(ii) the alpha-amylase level:

(iii) the degree of root and shoot growth;

(iv) the total nitrogen content and the soluble nitrogen ratio; and/or

(v) the diastatic power;

has been modified in comparison to conventionally germinated non-water stressed green malt.

As shown in Examples section 1 (laboratory conditions), the soluble sugars content may be upto 500% greater than, and the alpha-amylase content upto 250% greater than that of green malt produced by conventional malting processes. The increased amount of soluble sugars found in germinated malting grain produced in the germination step of the process of the present invention (total soluble sugars measured as mg/g. fresh weight) over, for example, a period of 4 days is generally upto 500% higher than the amounts of soluble sugars found in grain subjected to conventional germinating conditions over a 6 day time Interval. Generally, the soluble sugars content can be increased from about 3%-350% or more depending on grain variety, more usually from about 3%-200%, more usually still from about 3%-190%. Naturally, the skilled artisan will appreciate that the amount of increase in soluble sugars will in part be dependent on the nature of the grain variety used and the length of time the malting grain is exposed to the modified germinating conditions of the malting process of the invention. In addition, it has been found that the alpha-amylase levels undergo an increase (measured change O.D./mg fresh weight) of upto 250% or more depending on variety, and length of time of exposure to the modified germinating conditions of the malting process of the present invention. Generally, the increase in alpha-amylase levels lies in the range of from 30%-140%, more generally from about 35%-125% depending on the length of time of exposure to the malting conditions of the present invention. As an example, the exposure time for the whole of the germination step illustrated in the examples of the present invention was 144 hrs, of which for 24-48 hrs, the malting grain was subjected to a mild water stress as hereindescribed in the examples section. The skilled artisan will appreciate that depending on the end use of the malt of interest, the Water stress imparting element of the germination step, in terms of time could be longer or shorter but generally would not be expected to be less than about 24 hrs and may be up to 48 hrs or longer, depending on the grain variety of interest. The skilled artisan will also appreciate that the mild water stress aspect of the germination conditions of the present invention can be imparted to the malting grain after germination is observed and may be applied continuously, for example over 24-48 hours or may be applied discontinuously, that is in ‘blocks’ of a few hrs spread over the entire germination step, for example in bursts of 6-12 hours every 6-12 hours once germination is observed. However, for ease of operation it is envisaged that the mild water stress aspect of the germination conditions of the present invention is applied continuously as outlined above.

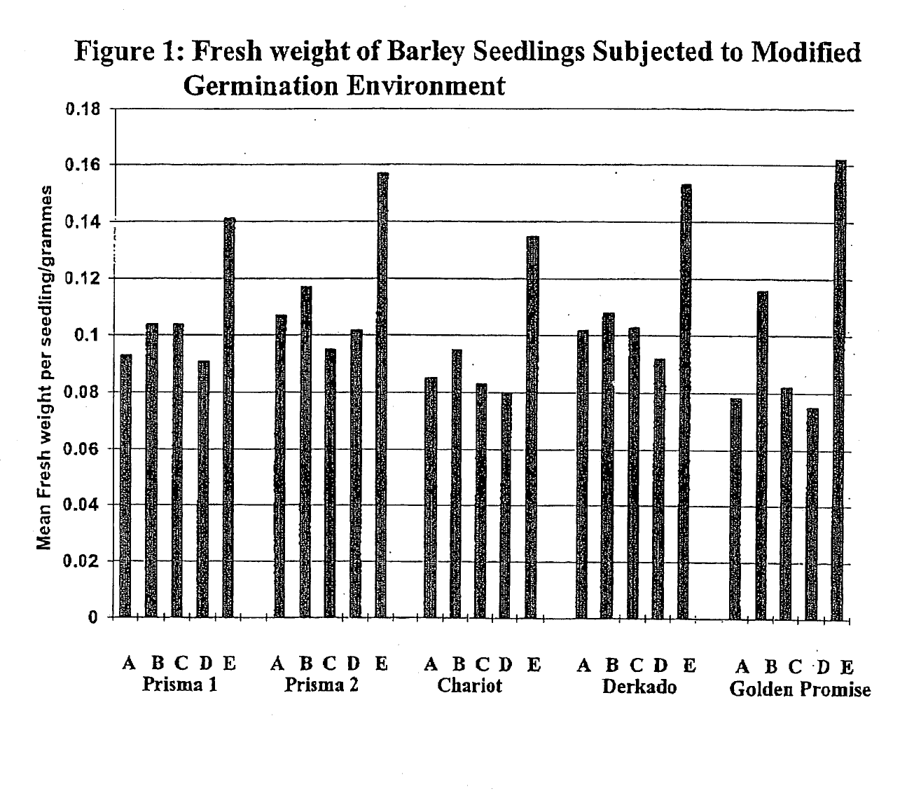

In addition to altered levels of certain components as herein described, it has also been found that the green malt of the instant invention does not show a concomitant gain in fresh weight. In fact, seed batches are found to lose a percentage of their fresh weight during the mild water stress phase of the germination step, as illustrated, for example in FIG. 1 and Tables 1-5 herein. The loss of fresh weight is thought to be due in large part to moisture loss. Thus, it is clear that rootlet growth is arrested in the green malt produced by the process of the instant invention. According to a further embodiment of the invention there is provided dried malted grain suitable for storage having a moisture content of from 4-8%, preferably from 4-6% wherein at least one or more of parameters (i)-(v) are altered, typically elevated, relative to dried malted grain produced under conventional malting process conditions.

According to a further embodiment of the invention there is provided malted grain obtainable by the process of the present invention as hereinbefore described. For the purposes of the present invention ‘malted grain’ in the context of this aspect of the invention includes green malt; green malt which has been kilned ie malt kilned prior to storage which may include culms; kilned malt from which the culms have been removed using conventional methods commonly employed in the art; and kilned malt from which the culms have been removed which has been crushed or rendered into powdered form using conventional methods commonly employed in the art ready for storage and/or immediate use. Naturally, the skilled artisan will appreciate that dried malted grain and/or dried crushed malt or dried powdered malt derived from the process of the invention as hereindescribed will possess altered levels, typically elevated levels of the relevant components as hereindescribed.

In a further embodiment of the present invention there is provided use of malt prepared according to the present invention in the production of beers, lagers, ales, stouts, barley wines and whiskies (both single malt whisky and blended whisky), malt vinegar, malt extracts (powders and syrups), diastase, gin, vodka, and alcohol.

In a further embodiment of the present invention there is provided rootlets separated from malted grain of the invention for use in animal feedstuffs.

In a further embodiment of the present invention there is provided rootlets from malted grain of the invention for use in the preparation of growth and/or maintenance media for micro-organisms, such as yeast and bacteria.

In a further embodiment there is provided malt extract derived from malted grain produced by the process of the present invention.

In a further embodiment, there is provided use of malted grain of the present invention in the preparation of wort for use in the manufacture of whisky.

In a further embodiment, there is provided use of malted grain of the present invention in the preparation of wort suitable for use in the manufacture of beers, lagers, ales, stouts, and barley wines.

The invention will now be illustrated with reference to the accompanying examples. It is to be understood that the examples are not to be viewed as limiting the scope of the invention in any way. The tables referred to in the Examples Section are shown immediately thereafter.

FIG. 1: Fresh weight of barley seedlings subjected to a modified germination environment.

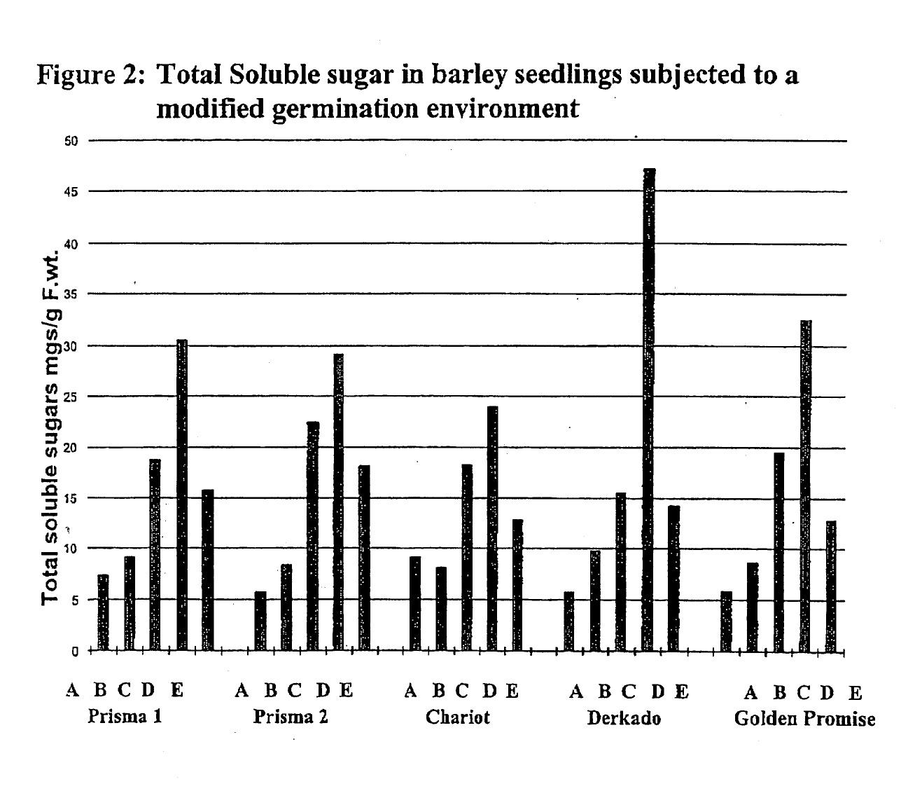

FIG. 2: Total soluble sugars in barley seedlings subjected to a modified germination environment.

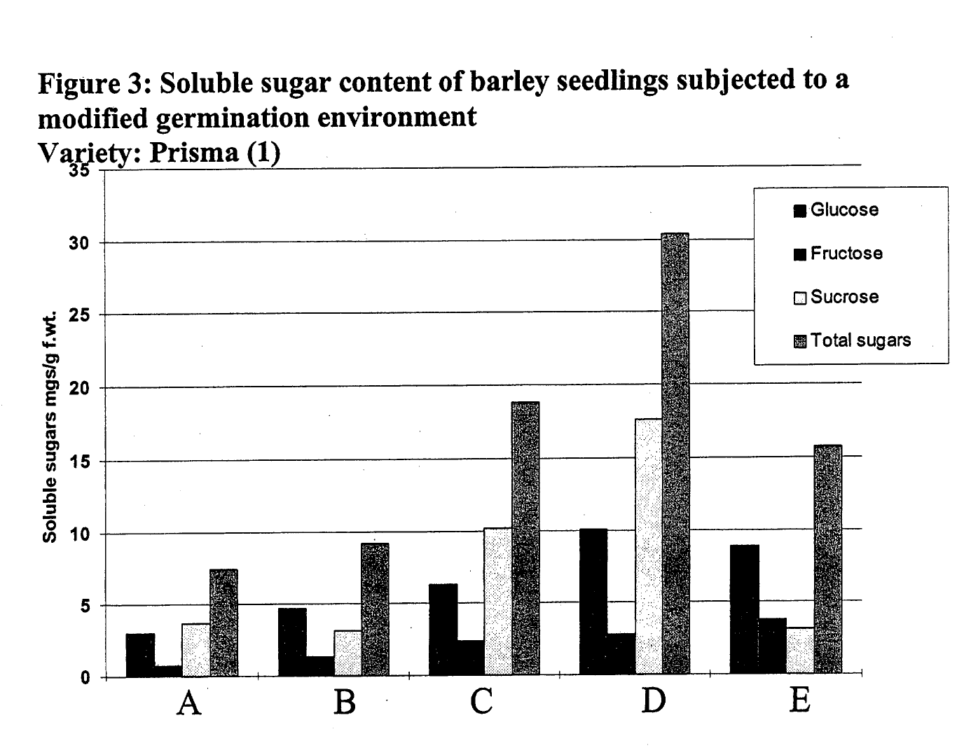

FIG. 3: Soluble sugar content of barley seedlings subjected to a modified germination environment cv: Prisma (1).

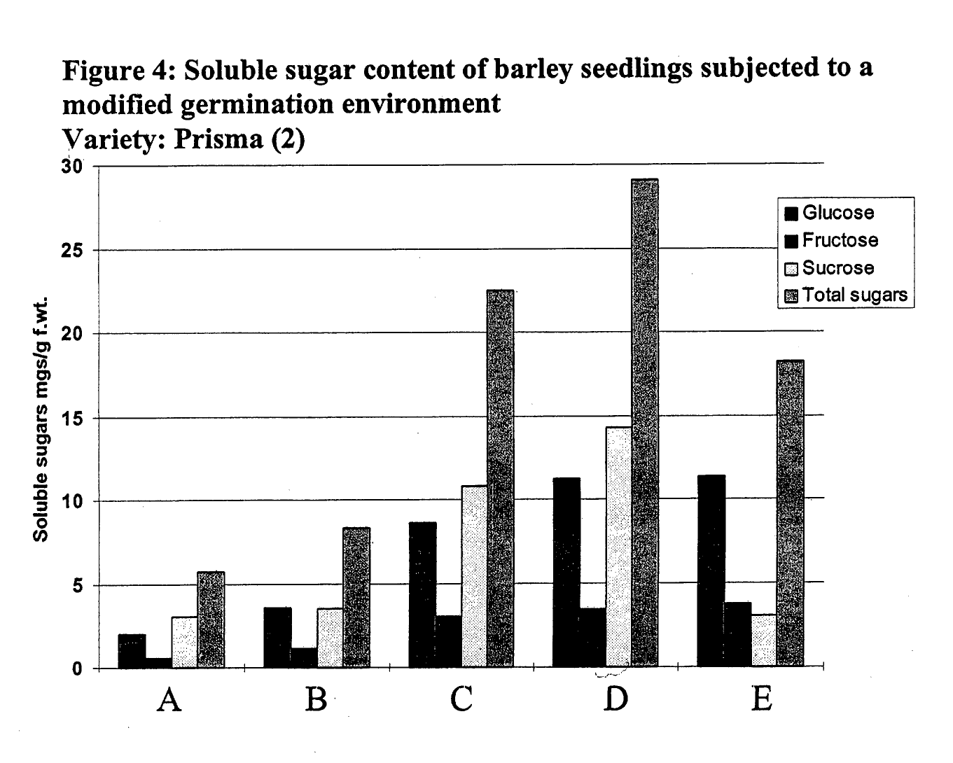

FIG. 4: Soluble sugar content of barley seedlings subjected to a modified germination environment cv: Prisma (2).

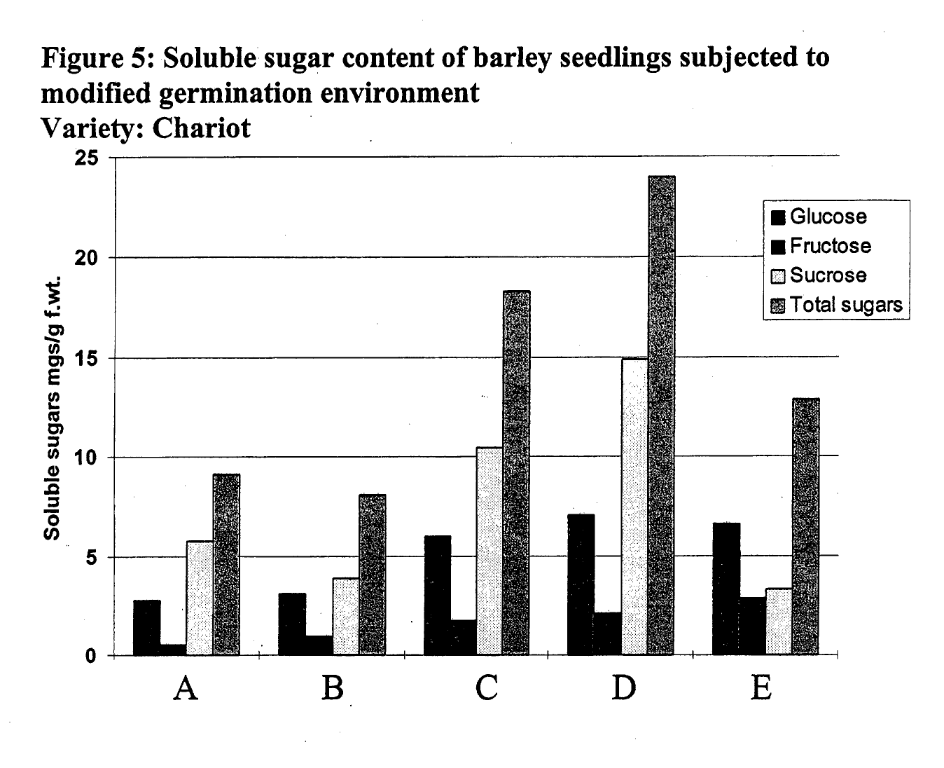

FIG. 5: Soluble sugar content of barley seedlings subjected to a modified germination environment cv: Chariot.

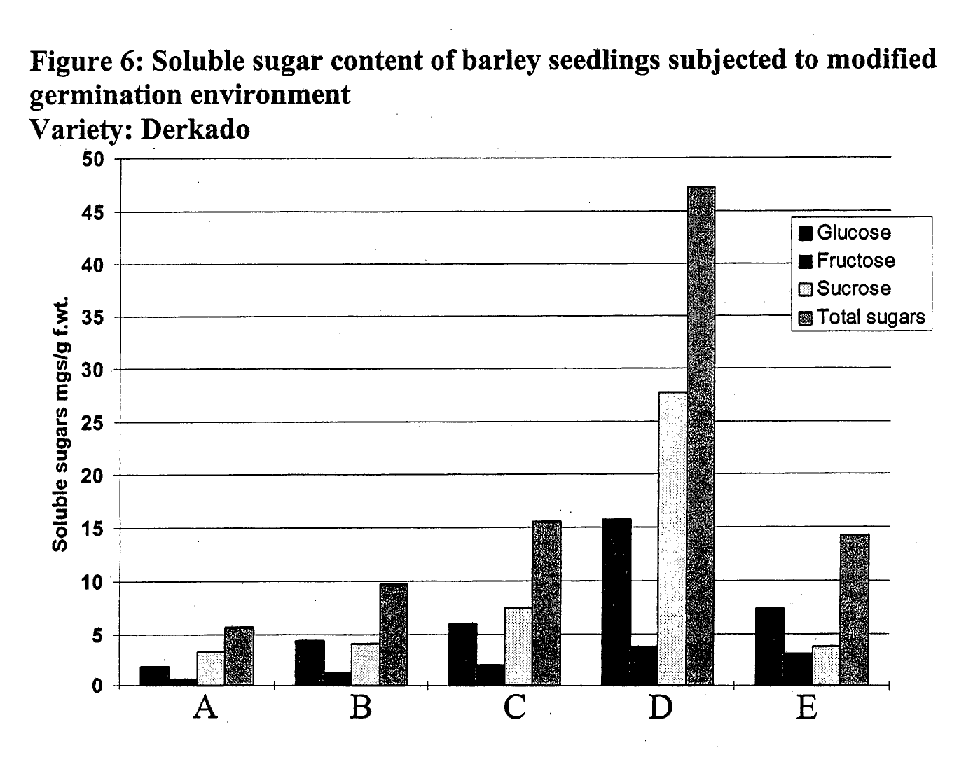

FIG. 6: Soluble sugar content of barley seedlings subjected to a modified germination environment cv: Derkado.

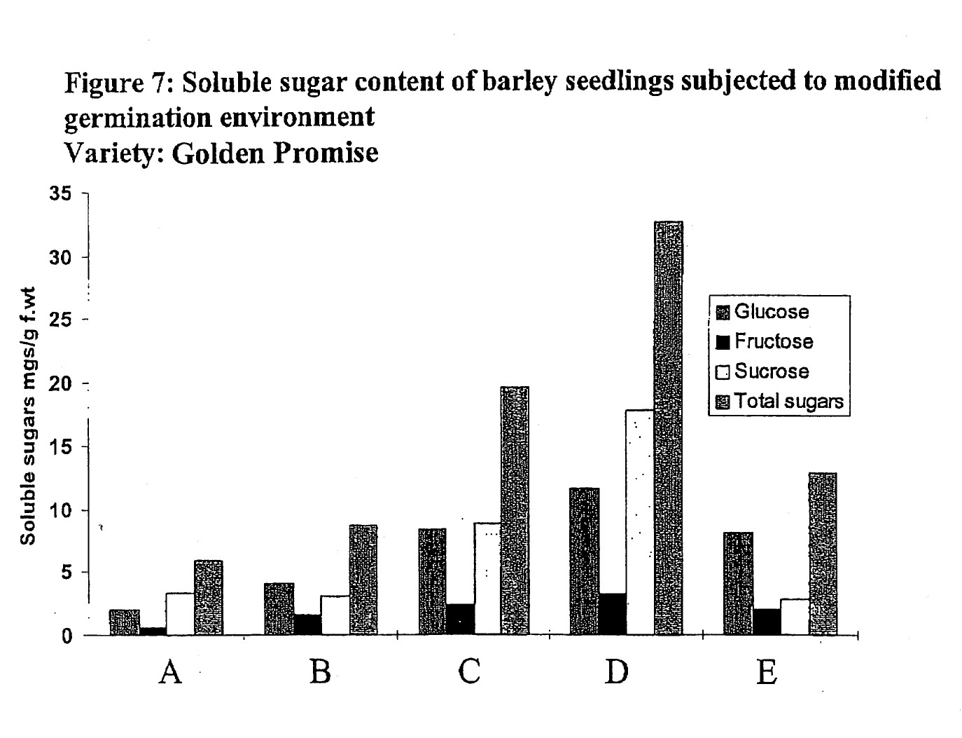

FIG. 7: Soluble sugar content of barley seedlings subjected to a modified germination environment cv: Golden Promise.

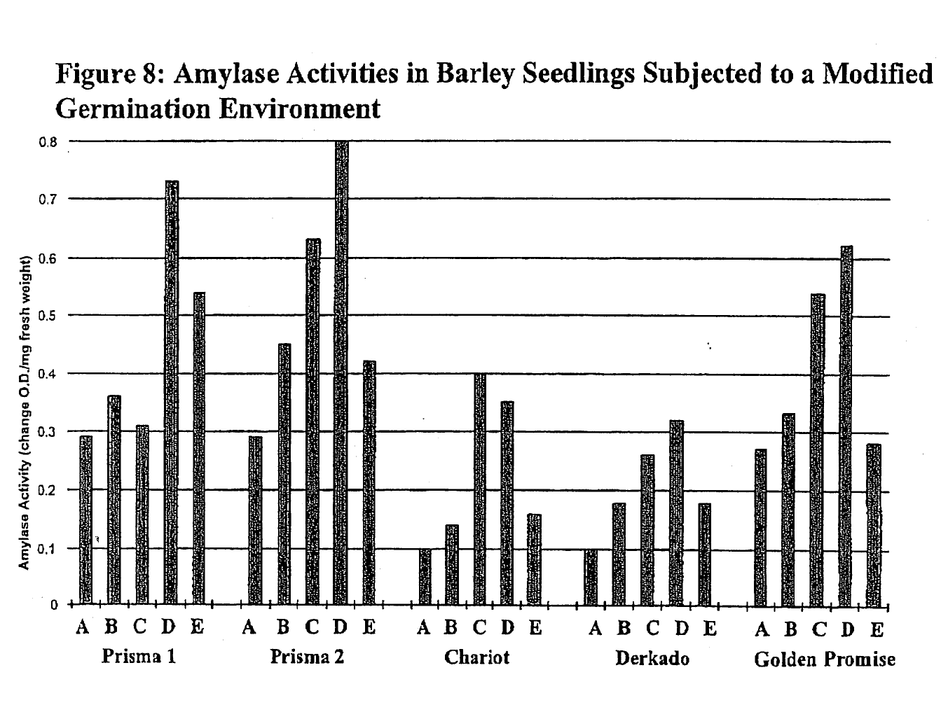

FIG. 8:. Amylase activities in barley seedlings subjected to a modified germination environment.

### EXAMPLES SECTION 1

### Laboratory Scale

Seed Batches

Four varieties of barley used in the brewing and/or whisky distilling industry were used in all experiments. Two separate batches of one of these varieties, Prisma, were available at the outset therefore a total of 5 seed batches were used in all experiments. The two Prisma batches were designated Prisma 1 and Prisma 2.

The batches are: Prisma 1, Prisma 2, Chariot, Derkado and Golden Promise

Seed Preparation

10 grams of seeds from each batch were placed in a 500 ml conical flask and rinsed in distilled water. 300 ml distilled water was placed in the flask and this was placed at 4° C. for 40 hrs in the dark.

After this time seeds were spread evenly onto two sheets of 3MM Whatmann filter paper, cut to size and placed into a 15 cm petri dish. A further two sheets of the same filter paper, also cut to size, was placed on top of the seeds. The entire ‘sandwich’ of filter paper and seeds was completely saturated with distilled water to the point where an excess of 2-3 mls of water appeared in a pool when the plate was tipped at an acute angle. The lid was placed on the dish and fixed in position with micropore tape.

Growth Conditions

The dishes were placed in a growth cabinet maintained at a constant temperature of 18° C. and 100 microeinsteins (micromoles/m²/sec) fluorescent light. 96-100% germination was observed in all cases over 72 hours.

Developmental Stages Used in Experiments

The following nomenclature is used to designate developmental stage and experimental treatment. This nomenclature is used in all the figures and tables presented herein.

A=3-4 root stage prior to coleoptile emergence.

B=Coleoptile 3-4 mm long. This stage is observed after 4 days growth.

C=Seedlings subjected to 24 hrs mild water stress.

D=Seedlings subjected to 48 hrs mild water stress.

E=Six day old seedlings not subjected to any water stress. Seeds were kept in a sealed petri dish under moist conditions for the same 48 hour period as treatments C and D. This 2 day period represents a period of rapid growth and the coleoptile and roots extend rapidly. In sample E, the acrospire is 2-3 cm long and the root system is well developed.

Sampling and Water Stress Treatment

Petri dishes were removed from the growth cabinet to the lab. bench at appropriate times and seedlings were removed, weighed, and immediately frozen in liquid nitrogen and stored at −80° C. Care was taken to remove excess water from seedlings prior to weighing In all cases two lots of five seedlings were sampled. One sample was used for sugar analyses and the second sample for amylase enzyme activity analysis.

Sample A—this was obtained after 3 days growth under moist conditions.

Sample B—this was obtained after 4 days growth under moist conditions.

Water Stress Treatment

Samples C and D—Two lots of 10 seedlings (identical to sample B seedlings) were placed in a 9 cm petri dish and the lid was fixed in position with micropore tape. The seedlings were not dried prior to placing in the dish and water was not added thereto. Petri dishes were returned to the growth cabinet for a period of 24 and 48 hours to give samples C and D, respectively. This arrangement (i.e., the fixing of the lid to the dish with micropore tape) gives optimal conditions to impose a mild water stress without giving rise to severe desiccation.

From FIG. 1 showing fresh weight of different samples, it can be seen that in all five seed batches analysed the fresh weight is less in sample D than in sample B. The point to note from FIG. 1 is that gain in fresh weight exhibited by sample E in all 5 seed batches does not occur in the samples subjected to a mild water stress.

Details of fresh weight measurements are provided in Tables 1-5. It should be noted that seedlings representing replicate 1 fresh weight measurements in each case were used for amylase activity determination and replicate 2 seedlings were used for the sugar assays.

Sugar Assays

Each sample was ground in liquid nitrogen and the powdered extract was transferred directly to 5 mls boiling 80% ethanol in a capped 15 ml tube and maintained under these conditions for 60 minutes. Samples were centrifuged at 2000 g for 10 minutes and the resulting supernatant was completely evaporated under vacuum. The residue was re-suspended in 1.5 mls distilled water.

The amount of glucose, fructose and sucrose in the samples was determined using the enzyme-linked spectrophotometric assay described by Stitt et al (1989) Methods in Enzymology 174, pages 518-552. Results of the analysis are provided in FIGS. 2-7 and Tables 6-11. FIG. 2 presents total is soluble sugars in the various samples of each seed batch. It is apparent that sample D (48 hrs water stress) in all cases has higher levels of soluble sugars than or E. In all cases except one, sample C (24 hrs of water stress), is also higher.

The difference between samples C and D versus E cannot be accounted for by an increase in freshweight of sample E alone. Close inspection of Tables 6-11 show that the absolute amounts of sugars in the extracts from 5 seedlings is greater in C and D compared to E and this difference is further magnified when the data is presented on a fresh weight basis.

A point to note from FIGS. 3—which present the soluble sugar content in the different varieties is that glucose, fructose and sucrose levels all increase in samples C and D. However, it should be noted that sucrose levels are by far the most responsive. For example, a comparison of glucose levels in samples D and E shows that in only one variety (Derkado, FIG. 6) is there a marked difference.

Amylase Assays

Samples were ground to a fine powder in a mortar and pestle using liquid nitrogen. Frozen powder was placed in 1 ml extraction buffer (0.2 mM sodium acetate, pH=4.8, 20 mM calcium chloride) and subsequently diluted 5×fold with ice cold distilled water. Samples were centrifuged at 4000 g for 10 minutes and the supernatant was decanted to a fresh tube.

An iodine assay as described by Reeve & Crozier pp35-39, in “Gibberellins and Plant Growth” (1975) Ed. Krishnamoorthy H DP Wiley Eastern Limited (ISBN 0 85226 488 7) was used to determine amylase activity-using solubilised potato starch as substrate.

The results of the amylase activity measurements are presented in FIG. 8 and Tables 11-13. The pattern is remarkably similar to that for levels of soluble sugars in the same samples. Points to note are that the levels of amylase activity recovered from the two Prisma batches are similar and higher than activities recovered from Chariot and Derkado. This suggests overall varietal differences and that mild water stress is resulting in significant effects on biochemical events in the developing seed.

### EXAMPLES SECTION 2

### Micro-Malting

Materials and Methods

Barley Samples

Chariot and Halcyon were obtained from the Heriot-Watt University brewing store. Golden Promise and Fanfare were supplied by Moray Firth Malt Limited.

Malting of Barley

Barley samples of grain (varieties: Fanfare, Golden Promise, Halcyon and Chariot) were screened to pass through a 2.2 mm diameter sieve to remove small and broken grains. Each of the four barley varieties (2 boxes of 400 g per variety) was steeped at 16° C. in a steeping vessel of a Seeger micro-malting plant (Seeger Machinenfabric, Fellbach, Germany) for 8 h, allowed a 16 h air-rest, followed by 24 h steep at 16° C. Steeped samples were transferred to the Seeger micro-malting germination box for germination at 18° C. until root growth was approx. 1 cm. For the control batches of the barley samples, water spray was applied (5 ml/200 g barley/day, Agu R. C. and Palmer, G. H. (1997) Process Biochemistry 32, pp500-507). No water spray was applied to test batches of barley, but the grains were turned daily. Samples were kilned at 55° C. for 24 h after the germination period was completed and rootlets removed.

Water Uptake

Samples of Chariot, Fanfare, Golden Promise, and halcyon were steeped and kilned as described (see below). The percentageout of steep moisture of the grains is shown in Table 1. The moistures achieved were: Chariot 45%; Fanfare 42%; Golden Promise 45%; and Halcyon 42%.

Malt Analyses

(i) Diastatic Power of Malt (Institute of Brewing, 1989 Recommended Methods of Analysis, Institute of Brewing, London)

The Fehlings method as described in the “Laboratory Methods in Malting of Heriot-Waft University—An Anthology” herein incorporated in its entirety by reference was used in the determination of malt diastatic power.

Calculation of diastatic power:

$$DP = \frac{2000}{x y} =$$

where

x=the number of ml of malt extract used in the conversion

y=the number of ml of conversion liquor used in titration

(ii) Mashing of Barley Malt, “Hot Water Extract” (Institute of Brewing, 1989, supra)

Barley malt was milled using the Buhler-Miag mill (0.7 mm grind). Ground malt was mashed for 1 h at 65° C. in the BRF mashing bath (Crisp Malting Limited, Great Ryburgh, UK). The mash was then filtered with re-filtration of the first 50 ml turbid wort.

Extract Determination

The specific gravity of the extract was obtained by feeding a sample of the filtrate from the barley malt mash into a density meter (Calculating Digital Density Meter, Stanton Redcroft PMR DMA 46). The extract was obtained from the relationship:

Extract(as is) 1°/Kg=Excess gravity×10.13

The soluble extract, the fermentability (%) of the soluble extract and the calculation of the fermentable extract (%) were made according to the Institute of Brewing (1989), section 2.15—Fermentability of Distilling (unboiled) worts.

(iii) Total Nitrogen (TN) of Malt and Total Soluble Nitrogen (TSN) of Wort (Institute of Brewing, 1989)

Total nitrogen of malt and total soluble nitrogen of wort were determined by the Kjeldahl method. Samples (10 ml of wort “hot water extract” from (ii) above or 1 g of malt) were digested using the Tecator System 2020 digester block, while the distillation unit was the Tecator Kjeltec System 1002 Distillation unit. The titration unit was the Metrohm Multi-burette E485 System.

For malt, total nitrogen was obtained from the relationship:

$$TN ( \% ) = \frac{Titre ( ml ) \times 14.008}{Wt of sample \times DM}$$

For total soluble nitrogen, the results were obtained from the relationship:

$$TSN ( \% ) = \frac{Titre ( ml ) \times 14.008}{DM}$$

where DM=% dry matter.

(iv) Sugars Present in the “Hot Water Extracts”

HPLC was used for the determination of soluble sugars present in the extracts. The HPLC equipment used to assess the sugars present in the wort was the Dionex Eluent Degas Module with the following components: Dionex PED (Pulsed Electrochemical Detector) with gold electrode, Dionex DX300 APG (advanced gradient pump), Gilson 234 autoinjector, Hewlett Packard Chemstation data handling (HP3365). The columns used were the Dionex Carbopac PA-100 Guard column, 4×50 mm and the Dionex Carbopac PA-10 column, 4×250 mm. Samples were diluted as necessary, injected and run on file 1 programme. All standard deviations were less than 0.6%.

(v) Measurement of Gain in Weight

To determine the percentage out-of-steep gain in weight and the subsequent gain in weight during the germination process, 100 corns were used. The data are expressed either based on the dry weight “as is” or the weight of the grains after steeping. The definition of “as is” is the weight of corns taken from storage without any further drying, as would be done to obtain dry weights. The measurements are based on the weight of corns including the moisture they contain when taken for use. Determinations were done in duplicate. The results were obtained as follows:

$$\frac{{W}_{1} - {W}_{2}}{{W}_{2}} \times 100$$

where

W₁=weight of steeped or germinating sample

W₂=weight of barley sample “as is”

Fresh weight gain in both control and treated samples were checked daily during germination.

Results

Effect of Stressing Grains by the Absence of Sprinkling During Germination on Sugar Levels in a Hot Water Extract

TABLE 14

| mg/l | GP-S | GP-NS | Ch-S | Ch-NS | Fa-S | Fa-NS | Ha-S | Ha-NS |
|---|---|---|---|---|---|---|---|---|
| Gluco | 3971 | 3697 | 5060 | 5268 | 4058 | 3805 | — | — |
| Fruct | 497 | 463 | 667 | 614 | 486 | 408 | — | — |
| Sucro | 4144 | 4117 | 3946 | 4049 | 3504 | 3448 | — | — |
| Malto | 43487 | 47242 | 45047 | 47319 | 46581 | 47861 | — | — |
| Maltrio | 7268 | 7510 | 7207 | 7638 | 7032 | 7284 | — | — |

GP—Golden Promise; Ch—Charlot; Fs—Fanfare; Ha—halcyon; S—Sprinkled; NS—Non-Sprinkled Gluco—glucose: Fruct—fructose; Sucro—sucrose, Malto—maltose; and Maltrio—maltotriose.

It is evident from Table 14 that the maltose (the major fermentable sugar In wort) and maltotriose recordings were elevated by up to 8% and 6%, respectively, relative to controls. All varieties tested showed increases of from 3-8% and 2-6%, respectively. These results indicate that grains subject to water stress may provide higher fermentable extracts.

TABLE 15
The effect of stressing grains by the absence of sprinkling during
germination on nitrogen levels of malt produced using
Chariot, Fanfare and Halcyon.

| | Sprinkled | Non-Sprinkled |
|---|---|---|
| Chariot | | |
| Total nitrogen (%) | 1.51 | 1.53 |
| Total sol. Nitrogen (%) | 0.51 | 0.58 |
| Soluble nitrogen ratio | 0.34 | 0.38 |
| Diastatic Power (°L) | 154 | 171 |
| Fanfare | | |
| Total nitrogen (%) | 1.47 | 1.56 |
| Total sol. Nitrogen (%) | 0.52 | 0.53 |
| Soluble nitrogen ratio | 0.35 | 0.34 |
| Diastatic Power (°L) | 110 | 113 |
| Halcyon | | |
| Total nitrogen (%) | 1.44 | 1.46 |
| Total soluble nitrogen | 0.43 | 0.49 |
| Soluble nitrogen ratio | 0.30 | 0.34 |
| Diastatic Power (°L) | 118 | 114 |

It is evident from Table 15 that the total nitrogen, total soluble nitrogen, and soluble nitrogen ratio for grains subjected to a water stress is generally higher than for grains not subjected to a water stress. The SNR ratio is also shown to be Increased by up to 12%, depending on variety. Varieties Chariot and Fanfare show increased SNR of 10 and 12%, respectively over non-stressed grain.

Increases in diastatic power of upto 11% are also observed.

These results indicate that the nitrogen content of grain can be enhanced by imposing a water stress on germinating grain.

TABLE 16
Percentage (%) gain in weight profile of Golden Promise, Fanfare,
Chariot and Halcyon after steep and during germination

| | % Gain in Weight | |
|---|---|---|
| | Sprinkled | Non-Sprinkled |
| Golden Promise | | |
| Out of steep | 61.7 | 61.7 |
| Day 1 (root about 1 cm) | 68.4 | 68.4 |
| Day 2 | 66.5 | 68.2 |
| Day 3 | 68.2 | 62.6 |
| Day 4 | 66.2 | 62.3 |
| Day 5 | 65.9 | 54.7 |
| Chariot | | |
| Out of steep | 57.1 | 57.1 |
| Day 1 (root about 1 cm) | 56.6 | 56.6 |
| Day 2 | 55.0 | 57.3 |
| Day 3 | 60.1 | 48.5 |
| Day 4 | 50.6 | 44.3 |
| Day 5 | 50.6 | 44.1 |
| Fanfare | | |
| Out of steep | 45.6 | 45.6 |
| Day 1 (root about 1 cm) | 58.0 | 58.0 |
| Day 2 | 51.6 | 53.2 |
| Day 3 | 55.1 | 47.3 |
| Day 4 | 52.7 | 47.0 |
| Day 5 | 53.7 | 48.0 |
| Halcyon | | |
| Out of steep | 54.3 | 54.3 |
| Day 1 (root about 1 cm) | 54.5 | 54.5 |
| Day 2 | 59.5 | 49.6 |
| Day 3 | 59.7 | 50.4 |
| Day 4 | 58.7 | 50.6 |
| Day 5 | 56.9 | 53.5 |

Table 16 indicates that all varieties placed under a mild water stress show a reduced gain in weight relative to controls. The reduced gain in weight from these results shows a difference of upto 13%, depending on variety.

### SUMMARY

The combined results of Tables 14-16 indicate that grain subjected to a mild water stress is not only viable and displays desirable alterations, generally increases, in nearly all of the measured seed parameters (ie sugar, nitrogen related measurements and diastatic power) and a reduced gain in weight over time. This reduced gain in weight was observed to coincide with arrestation of rootlet growth.

TABLE 1
Fresh weight of barley seedlings subjected to a
modified germination environment
Variety: Prisma 1

| Sample | A | B | C | D | E |
|---|---|---|---|---|---|
| rep1 | 0.500 | 0.520 | 0.510 | 0.430 | 0.620 |
| rep2 | 0.430 | 0.520 | 0.530 | 0.480 | 0.790 |
| Mean F.wt./five seedlings | 0.465 | 0.520 | 0.520 | 0.455 | 0.705 |
| Mean F.wt/seedling | 0.093 | 0.104 | 0.104 | 0.091 | 0.141 |

TABLE 2
Fresh weight of barley seedlings
subjected to a modified germination environment
Variety: Prisma 2

| Sample | A | B | C | D | E |
|---|---|---|---|---|---|
| rep1 | 0.550 | 0.580 | 0.470 | 0.510 | 0.800 |
| rep2 | 0.520 | 0.590 | 0.480 | 0.510 | 0.770 |
| Mean F.wt./five seedlings | 0.535 | 0.585 | 0.475 | 0.510 | 0.785 |
| Mean F.wt/seedling | 0.107 | 0.117 | 0.095 | 0.102 | 0.157 |

TABLE 3
Fresh weight of barley seedlings subjected to a
modified germination environment
Variety: Chariot

| Sample | A | B | C | D | E |
|---|---|---|---|---|---|
| rep1 | 0.430 | 0.450 | 0.400 | 0.410 | 0.700 |
| rep2 | 0.420 | 0.500 | 0.430 | 0.390 | 0.660 |
| Mean F.wt./five seedlings | 0.425 | 0.475 | 0.415 | 0.400 | 0.675 |
| Mean F.wt/seedling | 0.085 | 0.095 | 0.083 | 0.08 | 0.135 |

TABLE 4
Fresh weight of barley seedlings subjected to a
modified germination environment
Variety: Derkado

| Sample | A | B | C | D | E |
|---|---|---|---|---|---|
| rep1 | 0.520 | 0.600 | 0.520 | 0.420 | 0.760 |
| rep2 | 0.500 | 0.480 | 0.510 | 0.500 | 0.770 |
| Mean F.wt./five seedlings | 0.510 | 0.540 | 0.515 | 0.460 | 0.765 |
| Mean F.wt/seedling | 0.102 | 0.108 | 0.103 | 0.092 | 0.153 |

TABLE 5
Fresh weight of barley seedlings subjected to a
modified germination environment
Variety: Golden Promise

| Sample | A | B | C | D | E |
|---|---|---|---|---|---|
| rep1 | 0.400 | 0.590 | 0.410 | 0.380 | 0.800 |
| rep2 | 0.380 | 0.570 | 0.410 | 0.370 | 0.820 |
| Mean F.wt./five seedlings | 0.390 | 0.580 | 0.410 | 0.375 | 0.810 |
| Mean F.wt/seedling | 0.078 | 0.116 | 0.082 | 0.075 | 0.162 |

TABLE 6
Soluble sugar content of barley seedlings
subjected to a modified germination environment
Variety: Prisma (1)

| SAMPLE | A | B | C | D | E |
|---|---|---|---|---|---|
| rep1 | 0.039 | 0.017 | 0.019 | 0.011 | 0.008 |
| rep2 | 0.040 | 0.015 | 0.019 | 0.011 | 0.009 |
| rep3 | 0.040 | 0.010 | 0.017 | 0.010 | 0.008 |
| starting OD | 0.040 | 0.014 | 0.018 | 0.011 | 0.008 |
| mean A1 | | | | | |
| rep1 | 0.483 | 0.189 | 0.247 | 0.178 | 0.245 |
| rep2 | 0.493 | 0.180 | 0.262 | 0.178 | 0.250 |
| rep3 | 0.486 | 0.181 | 0.240 | 0.178 | 0.259 |
| after HK | 0.487 | 0.183 | 0.250 | 0.178 | 0.251 |
| mean A2 | | | | | |
| rep1 | 0.595 | 0.237 | 0.340 | 0.226 | 0.347 |
| rep2 | 0.606 | 0.227 | 0.351 | 0.224 | 0.359 |
| rep3 | 0.596 | 0.229 | 0.321 | 0.224 | 0.359 |
| after PGI | 0.599 | 0.231 | 0.337 | 0.225 | 0.355 |
| mean A3 | | | | | |
| rep1 | 1.158 | 0.362 | 0.730 | 0.525 | 0.435 |
| rep2 | 1.189 | 0.343 | 0.733 | 0.537 | 0.436 |
| rep3 | 1.167 | 0.346 | 0.722 | 0.530 | 0.462 |
| after invertase | 1.171 | 0.350 | 0.728 | 0.531 | 0.444 |
| mean A4 | | | | | |
| A2-A1 | 0.448 | 0.169 | 0.231 | 0.167 | 0.243 |
| A3-A2 | 0.112 | 0.048 | 0.088 | 0.047 | 0.104 |
| A4-A3/2 | 0.286 | 0.060 | 0.196 | 0.153 | 0.045 |
| Glu(g glu/L) | 0.858 | 1.622 | 2.216 | 3.206 | 4.656 |
| Fru(g glu/L) | 0.215 | 0.459 | 0.844 | 0.899 | 1.996 |
| Suc(g glu/L) | 1.052 | 1.097 | 3.594 | 5.625 | 1.642 |
| 1.5 ml extract | | | | | |
| fresh wt (g) | 0.430 | 0.520 | 0.530 | 0.480 | 0.790 |
| F. wt./g | | | | | |
| mg Glu/g F.wt. | 2.992 | 4.679 | 6.272 | 10.019 | 8.840 |
| mg Fru/g. F.wt. | 0.750 | 1.324 | 2.389 | 2.808 | 3.790 |
| mg Suc/g. F.wt. | 3.670 | 3.164 | 10.171 | 17.579 | 3.118 |
| Total Sugars mg/g F.wt. | 7.412 | 9.167 | 18.832 | 30.406 | 15.748 |

TABLE 7
Soluble sugar content of barley seedlings
subjected to a modified germination environment
Variety: Prisma (2)

| SAMPLE | A | B | C | D | E |
|---|---|---|---|---|---|
| rep1 | 0.034 | 0.012 | 0.021 | 0.011 | 0.011 |
| rep2 | 0.036 | 0.011 | 0.022 | 0.011 | 0.014 |
| rep3 | 0.040 | 0.011 | 0.020 | 0.010 | 0.010 |
| starting OD | 0.037 | 0.011 | 0.021 | 0.011 | 0.012 |
| mean A1 | | | | | |
| rep1 | 0.387 | 0.158 | 0.302 | 0.213 | 0.312 |
| rep2 | 0.401 | 0.160 | 0.313 | 0.208 | 0.324 |
| rep3 | 0.429 | 0.158 | 0.309 | 0.208 | 0.310 |
| after HK | 0.406 | 0.159 | 0.309 | 0.210 | 0.315 |
| mean A2 | | | | | |
| rep1 | 0.490 | 0.205 | 0.402 | 0.275 | 0.413 |
| rep2 | 0.518 | 0.208 | 0.417 | 0.271 | 0.427 |
| rep3 | 0.555 | 0.206 | 0.412 | 0.269 | 0.409 |
| after PGI | 0.521 | 0.206 | 0.410 | 0.272 | 0.416 |
| mean A3 | | | | | |
| rep1 | 1.040 | 0.360 | 0.769 | 0.542 | 0.504 |
| rep2 | 1.082 | 0.359 | 0.799 | 0.534 | 0.508 |
| rep3 | 1.164 | 0.358 | 0.791 | 0.534 | 0.495 |
| after invertase | 1.095 | 0.359 | 0.786 | 0.537 | 0.502 |
| mean A4 | | | | | |
| A2-A1 | 0.369 | 0.147 | 0.288 | 0.199 | 0.304 |
| A3-A2 | 0.115 | 0.048 | 0.101 | 0.062 | 0.101 |
| A4-A3/2 | 0.287 | 0.076 | 0.188 | 0.133 | 0.043 |
| Glu(g glu/L) | 0.707 | 1.411 | 2.759 | 3.813 | 5.818 |
| Fru(g glu/L) | 0.222 | 0.459 | 0.976 | 1.194 | 1.945 |
| Suc(g glu/L) | 1.056 | 1.403 | 3.456 | 4.871 | 1.581 |
| 1.5 ml extract | | | | | |
| fresh wt (g) | 0.520 | 0.590 | 0.480 | 0.510 | 0.770 |
| F. wt./g | | | | | |
| mg Glu/g. F.wt. | 2.039 | 3.588 | 8.622 | 11.214 | 11.334 |
| mg Fru/g. F.wt. | 0.641 | 1.167 | 3.049 | 3.511 | 3.789 |
| mg Suc/g. F.wt. | 3.046 | 3.568 | 10.800 | 14.328 | 3.080 |
| Total Sugars mg/g F.wt. | 5.726 | 8.323 | 22.471 | 29.053 | 18.202 |

TABLE 8
Soluble sugar content of barley seedlings
subjected to a modified germination environment
Variety: Chariot

| SAMPLE | A | B | C | D | E |
|---|---|---|---|---|---|
| rep1 | 0.038 | 0.168 | 0.012 | 0.008 | 0.009 |
| rep2 | 0.041 | 0.166 | 0.013 | 0.008 | 0.007 |
| rep3 | 0.039 | 0.168 | 0.011 | 0.007 | 0.010 |
| starting OD | 0.039 | 0.167 | 0.012 | 0.008 | 0.009 |
| mean A1 | | | | | |
| rep1 | 0.432 | 0.279 | 0.193 | 0.107 | 0.155 |
| rep2 | 0.454 | 0.274 | 0.196 | 0.100 | 0.156 |
| rep3 | 0.454 | 0.278 | 0.186 | 0.102 | 0.161 |
| after HK | 0.447 | 0.277 | 0.192 | 0.103 | 0.157 |
| mean A2 | | | | | |
| rep1 | 0.543 | 0.314 | 0.246 | 0.137 | 0.221 |
| rep2 | 0.469 | 0.309 | 0.250 | 0.129 | 0.221 |
| rep3 | 0.569 | 0.313 | 0.238 | 0.129 | 0.227 |
| after PGI | 0.527 | 0.312 | 0.245 | 0.132 | 0.223 |
| mean A3 | | | | | |
| rep1 | 1.360 | 0.461 | 0.574 | 0.354 | 0.294 |
| rep2 | 1.429 | 0.446 | 0.581 | 0.336 | 0.306 |
| rep3 | 1.434 | 0.453 | 0.557 | 0.336 | 0.306 |
| after invertase | 1.408 | 0.453 | 0.571 | 0.342 | 0.302 |
| mean A4 | | | | | |
| A2-A1 | 0.407 | 0.110 | 0.180 | 0.095 | 0.149 |
| A3-A2 | 0.080 | 0.035 | 0.053 | 0.029 | 0.066 |
| A4-A3/2 | 0.440 | 0.071 | 0.163 | 0.105 | 0.040 |
| Glu(g glu/L) | 0.780 | 1.051 | 1.721 | 1.827 | 2.848 |
| Fru(g glu/L) | 0.155 | 0.337 | 0.510 | 0.552 | 1.264 |
| Suc(g glu/L) | 1.619 | 1.299 | 2.996 | 3.867 | 1.452 |
| 1.5 ml extract | | | | | |
| fresh wt (g) | 0.420 | 0.500 | 0.430 | 0.390 | 0.650 |
| F. wt./g | | | | | |
| mg Glu/g. F.wt. | 2.787 | 3.152 | 6.004 | 7.025 | 6.573 |
| mg Fru/g. F.wt. | 0.552 | 1.011 | 1.780 | 2.123 | 2.918 |
| mg Suc/g. F.wt. | 5.782 | 3.897 | 10.453 | 14.871 | 3.351 |
| Total Sugars mg/g F.wt. | 9.122 | 8.060 | 18.237 | 24.019 | 12.843 |

TABLE 9
Soluble sugar content of barley seedlings
subjected to a modified germination environment
Variety: Derkado

| SAMPLE | A | B | C | D | E |
|---|---|---|---|---|---|
| rep1 | 0.037 | 0.009 | 0.017 | 0.029 | 0.020 |
| rep2 | 0.036 | 0.009 | 0.017 | 0.022 | 0.016 |
| rep3 | 0.038 | 0.009 | 0.017 | 0.025 | 0.020 |
| starting OD | 0.037 | 0.009 | 0.017 | 0.025 | 0.019 |
| mean A1 | | | | | |
| rep1 | 0.349 | 0.161 | 0.234 | 0.299 | 0.214 |
| rep2 | 0.345 | 0.150 | 0.225 | 0.295 | 0.216 |
| rep3 | 0.367 | 0.158 | 0.231 | 0.300 | 0.222 |
| after HK | 0.354 | 0.156 | 0.230 | 0.298 | 0.217 |
| mean A2 | | | | | |
| rep1 | 0.456 | 0.203 | 0.303 | 0.364 | 0.294 |
| rep2 | 0.447 | 0.188 | 0.300 | 0.364 | 0.295 |
| rep3 | 0.473 | 0.197 | 0.301 | 0.365 | 0.307 |
| after PGI | 0.459 | 0.196 | 0.301 | 0.364 | 0.299 |
| mean A3 | | | | | |
| rep1 | 1.037 | 0.358 | 0.579 | 0.853 | 0.401 |
| rep2 | 1.048 | 0.324 | 0.578 | 0.870 | 0.395 |
| rep3 | 1.096 | 0.339 | 0.580 | 0.878 | 0.416 |
| after invertase | 1.060 | 0.340 | 0.579 | 0.867 | 0.404 |
| mean A4 | | | | | |
| A2-A1 | 0.317 | 0.147 | 0.213 | 0.273 | 0.199 |
| A3-A2 | 0.105 | 0.040 | 0.071 | 0.066 | 0.081 |
| A4-A3/2 | 0.301 | 0.072 | 0.139 | 0.251 | 0.053 |
| Glu(g glu/L) | 0.607 | 1.411 | 2.041 | 5.224 | 3.806 |
| Fru(g glu/L) | 0.202 | 0.382 | 0.687 | 1.277 | 1.566 |
| Suc(g glu/L) | 1.106 | 1.327 | 2.552 | 9.240 | 1.936 |
| 1.5 ml extract | | | | | |
| fresh wt (g) | 0.500 | 0.480 | 0.510 | 0.500 | 0.770 |
| F. wt./g | | | | | |
| mg Glu/g. F.wt. | 1.820 | 4.411 | 6.002 | 15.673 | 7.415 |
| mg Fru/g. F.wt. | 0.607 | 1.193 | 2.020 | 3.832 | 3.051 |
| mg Suc/g. F.wt. | 3.318 | 4.146 | 7.506 | 27.721 | 3.772 |
| Total Sugars mg/g F.wt. | 5.745 | 9.750 | 15.528 | 47.226 | 14.238 |

TABLE 10
Soluble sugar content of barley seedlings
subjected to a modified germination environment
Variety: Golden Promise

| SAMPLE | A | B | C | D | E |
|---|---|---|---|---|---|
| rep1 | 0.037 | 0.014 | 0.013 | 0.018 | 0.165 |
| rep2 | 0.033 | 0.015 | 0.012 | 0.007 | 0.168 |
| rep3 | 0.036 | 0.013 | 0.013 | 0.007 | 0.166 |
| starting OD | 0.035 | 0.014 | 0.013 | 0.011 | 0.166 |
| mean A1 | | | | | |
| rep1 | 0.311 | 0.180 | 0.256 | 0.168 | 0.392 |
| rep2 | 0.289 | 0.176 | 0.245 | 0.158 | 0.398 |
| rep3 | 0.302 | 0.174 | 0.253 | 0.155 | 0.401 |
| after HK | 0.301 | 0.177 | 0.251 | 0.160 | 0.397 |
| mean A2 | | | | | |
| rep1 | 0.392 | 0.241 | 0.324 | 0.209 | 0.455 |
| rep2 | 0.365 | 0.238 | 0.310 | 0.199 | 0.453 |
| rep3 | 0.379 | 0.236 | 0.320 | 0.191 | 0.450 |
| after PGI | 0.379 | 0.238 | 0.318 | 0.202 | 0.453 |
| mean A3 | | | | | |
| rep1 | 0.860 | 0.373 | 0.589 | 0.448 | 0.532 |
| rep2 | 0.799 | 0.359 | 0.566 | 0.440 | 0.536 |
| rep3 | 0.839 | 0.356 | 0.587 | 0.429 | 0.540 |
| after invertase | 0.833 | 0.363 | 0.581 | 0.439 | 0.536 |
| mean A4 | | | | | |
| A2-A1 | 0.265 | 0.163 | 0.239 | 0.150 | 0.231 |
| A3-A2 | 0.078 | 0.062 | 0.067 | 0.041 | 0.056 |
| A4-A3/2 | 0.221 | 0.062 | 0.131 | 0.119 | 0.042 |
| Glu(g glu/L) | 0.508 | 1.558 | 2.288 | 2.868 | 4.420 |
| Fru(g glu/L | 0.150 | 0.594 | 0.642 | 0.796 | 1.072 |
| Suc(g glu/L | 0.835 | 1.143 | 2.414 | 4.363 | 1.532 |
| 1.5 ml extract | | | | | |
| fresh wt (g) | 0.380 | 0.570 | 0.410 | 0.370 | 0.820 |
| F. wt./g | | | | | |
| mg Glu/g. F.wt. | 2.007 | 4.101 | 8.365 | 11.625 | 8.085 |
| mg Fru/g. F.wt. | 0.593 | 1.562 | 2.348 | 3.217 | 1.961 |
| mg Suc/g. F.wt. | 3.294 | 3.007 | 8.833 | 17.687 | 2.802 |
| Total Sugars mg/g F.wt. | 5.894 | 8.671 | 19.546 | 32.539 | 12.848 |

TABLE 11
Amylase activity in barley seedlings subjected to a modified
germination environment
Variety: Prisma (1)

| SAMPLE | A | B | C | D | E |
|---|---|---|---|---|---|
| rep 1 | 0.808 | 0.763 | 0.812 | 0.578 | 0.473 |
| rep 2 | 0.832 | 0.657 | 0.775 | 0.358 | 0.438 |
| rep 3 | 0.778 | 0.743 | 0.759 | 0.478 | 0.397 |
| mean | 0.806 | 0.721 | 0.782 | 0.471 | 0.436 |
| Mean OD change | 0.294 | 0.379 | 0.318 | 0.629 | 0.664 |
| mean OD change/ul | 0.029 | 0.038 | 0.032 | 0.063 | 0.066 |
| extract | | | | | |
| mean | 147.0 | 189.5 | 159.0 | 314.3 | 332.0 |
| OD change/total extract | | | | | |
| Fresh weight/g | 0.5 | 0.52 | 0.51 | 0.43 | 0.62 |
| Mean OD change/g Fwt | 294.0 | 364.4 | 311.8 | 731.0 | 535.5 |
| Mean OD change/mg | 0.29 | 0.36 | 0.31 | 0.73 | 0.54 |
| Fwt | | | | | |

TABLE 12
Amylase activity in barley seedlings subjected to a modified
germination environment
Variety: Prisma (2)

| SAMPLE | A | B | C | D | E |
|---|---|---|---|---|---|
| rep 1 | 0.779 | 0.596 | 0.548 | 0.286 | 0.358 |
| rep 2 | 0.766 | 0.575 | 0.477 | 0.283 | 0.464 |
| rep 3 | 0.789 | 0.553 | 0.487 | 0.297 | 0.473 |
| mean | 0.778 | 0.575 | 0.504 | 0.289 | 0.432 |
| Mean OD change | 0.322 | 0.525 | 0.596 | 0.811 | 0.668 |
| mean OD change/ul | 0.032 | 0.053 | 0.060 | 0.081 | 0.067 |
| extract | | | | | |
| mean OD change/total | 161.0 | 262.7 | 298.0 | 405.7 | 334.2 |
| extract | | | | | |
| Fresh weight/g | 0.55 | 0.58 | 0.47 | 0.51 | 0.8 |
| Mean OD change/g Fwt | 292.7 | 452.9 | 634.0 | 795.4 | 417.7 |
| Mean OD change/mg | 0.29 | 0.45 | 0.63 | 0.80 | 0.42 |
| Fwt | | | | | |

TABLE 13
Amylase activity in barley seedlings subjected to a modified
germination environment
Variety: Chariot

| SAMPLE | A | B | C | D | E |
|---|---|---|---|---|---|
| rep 1 | 0.811 | 0.703 | 0.158 | 0.267 | 0.471 |
| rep 2 | 0.861 | 0.700 | 0.109 | 0.209 | 0.467 |
| rep 3 | 0.842 | 0.752 | 0.139 | 0.253 | 0.406 |
| mean | 0.838 | 0.718 | 0.135 | 0.243 | 0.448 |
| Mean OD change | 0.262 | 0.382 | 0.965 | 0.857 | 0.652 |
| mean OD change/ul | 0.009 | 0.013 | 0.032 | 0.029 | 0.022 |
| extract | | | | | |
| mean OD change/total | 43.7 | 63.6 | 160.8 | 142.8 | 108.7 |
| extract | | | | | |
| Fresh weight/g | 0.43 | 0.45 | 0.4 | 0.41 | 0.7 |
| Mean OD change/g Fwt | 101.6 | 141.4 | 401.9 | 348.4 | 155.2 |
| Mean OD change/mg | 0.10 | 0.14 | 0.40 | 0.35 | 0.16 |
| Fwt | | | | | |

1. A method of treatment of malting grain, in which the grain after commencement of germination under normal conditions within a grain-germinating environment but before completion thereof is subjected to water-restriction stress by reducing the amount of water available to the grain but maintaining an adequate oxygen supply to the grain within said environment for at least one time-interval sufficient to modify, as compared with conventionally germinated non water stressed grain, at least one of the following parameters, namely:
(i) the amount of soluble sugars in a hot water extract;
(ii) the alpha-amylase level;
(iii) the degree of root and shoot growth;
(iv) the total nitrogen content and the soluble nitrogen ratio; and/or
(v) the diastatic power;
as determined in the germinated and thus-treated grain.

2. A method as claimed in claim 1, wherein the grains are permitted to begin germination in an environment conducive to germination, and wherein the ambient conditions are subsequently altered to subject the grains to the water restriction stress.

3. A method of treatment of malting grain comprising the steps of:
a) treating the grain at a first relative humidity of at least 95%, at a temperature in the range from 12 to 25° C. for at least a first period of time; and
b) on at least one occasion during this treatment reducing the relative humidity to less than 95% and continuing to treat the grain at the said reduced relative humidity for at least a second period of time.

4. A method as claimed in claim 3, wherein the moisture content of the malting grains before step b) is in the range from 42 to 50%.

5. A method as claimed in any of claim 3 or claim 4, wherein the moisture content of the grain, after completion of step b) is maintained at a level no lower than 30%, and preferably is maintained within the range from 32% to 45% by weight of the seed.

6. A method as claimed in any of claims 3 to 5, wherein the second time period is in the range from 24 to 96 hours, preferably from 24 to 72 hours, and most preferably from 24 to 48 hours.

7. A method as claimed in any of claims 3 to 6, wherein the first period of time is in the range from a few hours to 6 days, and preferably from 1 to 4 days

8. A method as claimed in any of claims 3 to 7, wherein at completion of step a) the relative humidity is reduced by lowering the water vapour content of the ambient environment.

9. A method as claimed in any of claims 3 to 8, wherein during step b) the germinating grain is held at a temperature within the range from 0° C. to 25° C., preferably within the range from 0° C. to 18° C., and most preferably from 10° C. to 18° C.

10. A method as claimed in any of the preceding claims, wherein the grains are held in a germination chamber and the process is carried out therein.

11. A method as claimed in claim 10, wherein the relative humidity is reduced by re-circulating the air in the germination chamber thereby withholding additional water from the grain, but ensuring that an adequate oxygen supply to the grain is maintained.

12. A method according to claim 3, wherein a drying stage is performed between steps a) and b).

13. A method as claimed in claim 12 wherein the drying stage uses conventional drying methods to dry back the germinating grain relatively quickly.

14. A method according to claim 12 or 13, wherein the moisture content of the malting grains is reduced by up to 10% during the drying stage.

15. A method as claimed in any of claims 12 to 14, wherein the moisture content of the malting grain is reduced by 0.5% to 5%, and preferably by 2% to 5% during the drying stage.

16. A method as claimed in any of claims 12 to 15, wherein the moisture content of the malting grain after the drying stage is in the range from 30 to 35%, preferably about 32%, by weight of the grain.

17. A method as claimed in any of claim 12 to 16 wherein, during the drying stage, the malting grain is subjected to a temperature in the range from 0° C. to 25° C., and at a relative humidity in the range from 30% to 90%.

18. A method as claimed in any of claim 12 to claim 17, wherein drying is carried out at 20° C., at a relative humidity of 40%.

19. A method as claimed in any of claims 12 to 18, wherein the malting grain is dried to an overall water content which permits metabolic processes to continue but is sufficiently below that of germinating grain such that rootlet growth is substantially inhibited.

20. A method as claimed in any of claims 12 to 19, wherein the water content of the malting grain lies in the range from 30% to 55%, and more preferably in the range from 35% to 50% by weight of malting grain during step b).

21. A method as claimed in any of claims 12 to 20, wherein after the drying stage, the malting grain is transferred to an environment wherein moisture loss is prevented

22. A method as claimed in any of claims 3 to 21, wherein the first and second time periods are separated into a plurality of discrete phases of from 6 to 12 hours in length, and the process conditions are alternated between those of step a) and those of step b).

23. A method as claimed in any of the preceding claims, wherein the malting grain is selected from barley, wheat, sorghum, maize and rye.

24. A method of arresting rootlet growth in germinating grain including the step of incubating the grain in a grain germinating environment In which the amount of available water is controlled so as to subject the grains to a mild water restriction stress for a time interval suitable to inhibit metabolic process directed to rootlet growth but which does not substantially inhibit other vital metabolic processes in the grain.

25. Germinated and treated grain in which, at least one of the following parameters, namely:
(i) the amount of soluble sugars In a hot water extract;
(ii) the alpha-amylase level;
(111) the degree of root and shoot growth;
(iv) the total nitrogen content and the soluble nitrogen ratio; and/or
(v) the diastatic power;
has been modified in comparison to conventionally germinated non water stressed grain, when produced by a method according to any of claims 1 to 23.

26. Germinated grain according to claim 25, wherein the soluble sugars content is increased in the range from 3% to 500%.

27. Germinated grain according to claim 25 or claim 26, wherein the soluble sugars content is increased by 3% to 350%, preferably 3% to 200%, and more preferably from 3% to 190% as compared to germinated grain produced by conventional techniques.

28. Germinated grain according to claim 25, wherein the alpha-amylase levels are increased by up to 250% as compared to germinated grain produced by conventional techniques.

29. Germinated grain according to claim 25, wherein the alpha-amylase levels lies in the range from 30% to 140%, and preferably from 35% to 125% above those found in germinated grain produced by conventional techniques.

30 Treated green malt in which, at least one of the following parameters, namely:
(i) the amount of soluble sugars in a hot water extract;
(ii) the alpha-amylase level;
(iii) the degree of root and shoot growth;
(iv) the total nitrogen content and the soluble nitrogen ratio; and/or
(v) the diastatic power;
has been modified in comparison to conventionally germinated non water stressed green malt when produced by germinating grain by a method as claimed in any of claims 1 to 23.

31. A method of malting grain comprising the steps of
(i) cleaning and sizing the grain;
(ii) steeping the grain;
(iii) germinating the grain by a method as claimed in any of claims 1 to 23; and
(iv) kilning the grain.

32. Dried malted grain produced by a process according to claim 31, and suitable for storage, the dried malted grain having a moisture content of from 4 to 8%

33. Dried malted grain according to claim 32, wherein the moisture content is in the range from 4 to 6%.

34. Dried treated malted grain in which, at least one of the following parameters, namely:
(i) the amount of soluble sugars In a hot water extract;
(ii) the alpha-amylase level;
(iii) the degree of root and shoot growth;
(iv) the total nitrogen content and the soluble nitrogen ratio; and/or
(v) the diastatic power;
has been modified, in comparison to conventionally germinated non-water stressed malt grain.

35. The use of malt prepared according to claim 31, in the production of beers, lagers, ales, stouts, barley wines, whiskies, malt vinegar, malt extracts, diastase, gin, vodka, corn syrups and alcohol.

36. Malt extract derived from malted grains produced by a method according to claim 31.

37. The use of malted grains according to claims 32 or 33 in the preparation of wort for the manufacture of whisky, beers, lagers, ales, stouts, and barley wines or corn liquor for manufacture of corn syrups.

38. The use of germinated grains produced according to the methods of claims 1 to 23 in the preparation of wort for the manufacture of whisky, beers, lagers, ales, stouts, and barley wines.

39. A method of malting grain comprising the steps of
(i) cleaning and sizing the grain;
(ii) steeping the grain;
(iii) germinating the grain by a method as claimed in any of claims 1 to 28; and
(iv) kilning the grain.

40. Dried malted grain produced by a process according to claim 38 or claim 39, and suitable for storage, the dried malted grain having a moisture content of from 4 to 8%

41. Dried malted grain according to claim 40, wherein the moisture content is in the range from 4 to 6%.

42. Dried treated malted grain in which, at least one of the following parameters, namely:
(i) the amount of soluble sugars in a hot water extract;
(ii) the alpha-amylase level;
(iii) the degree of root and shoot growth;
(iv) the total nitrogen content and the soluble nitrogen ratio; and/or
(v) the diastatic power;
has been modified, in comparison to malt grain which has been normally germinated and is untreated.

43. The use of malt prepared according to claim 38 or 39, in the production of beers, lagers, ales, stouts, barley wines, whiskies, malt vinegar, malt extracts, diastase, gin, vodka, corn syrups and alcohol.

44. Rootlets separated from germinated grain germinated by a method according to any of claims 1 to 28.

45. Rootlets as claimed in claim 44, for use in the preparation of growth media or maintenance media for micro-organisms or in the preparation of animal feedstuffs.

46. Malt extract derived from malted grains produced by a method according to claim 38 or claim 39.

47. The use of malted grains according to claims 40 or 41 in the preparation of wort for the manufacture of whisky, beers, lagers, ales, stouts, and barley wines or corn liquor for manufacture of corn syrups.

48. The use of germinated grains produced according to the methods of claims 1 to 28 in the preparation of wort for the manufacture of whisky, beers, lagers, ales, stouts, and barley wines.
